(19) United States
(12) Patent Application Publication
(10) Pub. No.: US 2016/0071329 A1
(43) Pub. Date: Mar. 10, 2016

(54) Customized Video Creation System

(71) Applicant: You Kick Ass, Bellevue, WA (US)

(72) Inventor: Keri Andrews, Seattle, WA (US)

(21) Appl. No.: 14/707,705

(22) Filed: May 8, 2015

Related U.S. Application Data
(63) Continuation-in-part of application No. 14/477,811, filed on Sep. 4, 2014.

(51) Int. Cl. G06T 19/20; G06Q 20/32; G06Q 30/06; G06K 9/00; G06T 17/20

(52) U.S. Cl. CPC G06T 19/20; G06K 9/00281; G06T 17/20; G06Q 30/0601; G06Q 20/325

(57) ABSTRACT

Disclosed is an online system for creating a video with a customized 3D model of a head. The 3D model of the head is generated through an interactive process between a user at a remote computer and a hosted service on a local computer. Using at least one photograph, the hosted service enables the user to customize a generic 3D head form to adequately imitate the photograph provided by the user. Once created, the customized 3D model of the head may be incorporated into a pre-existing video to simulate the existence of the subject of the image in the video.

### CROSS REFERENCE TO RELATED APPLICATIONS

This patent application is a continuation-in-part of U.S. patent application Ser. No. 14/477,811, entitled “Customized Figure Creation System,” filed Sep. 4, 2014, which is hereby incorporated by reference for all purposes.

### TECHNICAL FIELD

The present invention relates to the field of customized three dimensional modeling, and more specifically, to the field of online services for creating customized three dimensional models.

### SUMMARY OF THE INVENTION WITH BACKGROUND INFORMATION

Three dimensional (“3D”) printing is growing rapidly in significance and popularity with the consuming public. Although still cost prohibitive for most individuals, it is easy to see the attraction of creating a real world instance of a digital representation of an object. Many uses for 3D printers are evolving.

Generally stated, embodiments are directed to an online system for creating a figure with a customized 3D model of a head. The head may be created using a 3D printer, and the 3D model of the head may be generated through an interactive process between a user at a remote computer and a hosted service on a local computer. Using at least one photograph, the hosted service enables the user to customize a generic 3D head form to adequately imitate the photograph provided by the user. Once created, the customized 3D model of the head may be physically instantiated using the 3D printer for attachment to an existing physical figure, or the entire physical figure (including the customized head) may be physically instantiated together.

Alternative embodiments are directed to an online system for creating a customized 3D model of a head. The 3D model of the head is created using input from a user, and

### BRIEF DESCRIPTION OF THE DRAWINGS

The teachings of the invention may be better understood with reference to the accompanying figures, in which are shown several preferred embodiments, when read in conjunction with the following detailed description.

FIG. 1 is a functional overview of one embodiment of a customized model creation system 100, in accordance with aspects of the invention.

FIG. 2 is a functional block diagram illustrating components of a remote computing system that may be implemented in certain embodiments.

FIG. 3 is a functional block diagram illustrating components of a local computing system that may be implemented in certain embodiments.

FIG. 4 is a functional block diagram generally illustrating elements of a video creator component that may be implemented in certain embodiments.

FIG. 5 is a conceptual representation of an interface that may be exposed by a local computing system for manipulating an image and creating a customized 3D model of a head, in accordance with one embodiment.

FIG. 6 is another conceptual representation of an interface that may be exposed by a local computing system for manipulating an image and creating a customized 3D model of a head, in accordance with one embodiment.

FIG. 7 is a conceptual representation of the creation of a physical instance of a customized figure, having a 3D model of a head based on an image provided by a user, in accordance with one embodiment.

FIG. 8 is a conceptual representation of the creation of a video incorporating a customized 3D model of a head based on an image provided by a user, in accordance with one embodiment.

Like numerals represent like elements throughout the several figures.

### DETAILED DESCRIPTION OF EMBODIMENTS

Embodiments of the invention will now be described with reference to the figures. Although specific embodiments are being described here, such embodiments are not limiting of the invention. These specific embodiments are for illustrative purposes only.

Briefly described, the disclosed embodiments illustrate a customized video creation system to allow users to connect over a network and provide an image. The video creation system then creates a 3D model based on that image and allows the user to manipulate and customize the 3D model. Once the 3D model is to the user's liking, the video creation system causes a video to be created that incorporates the 3D model. In one specific implementation, the preferred embodiment receives at least one image of a face over a network, creates a 3D model of a head resembling the face in the image, customizes the 3D model based on user input, and incorporates the 3D model of the head into a pre-existing video, thereby simulating the effect that the person captured in the image is a character in the video.

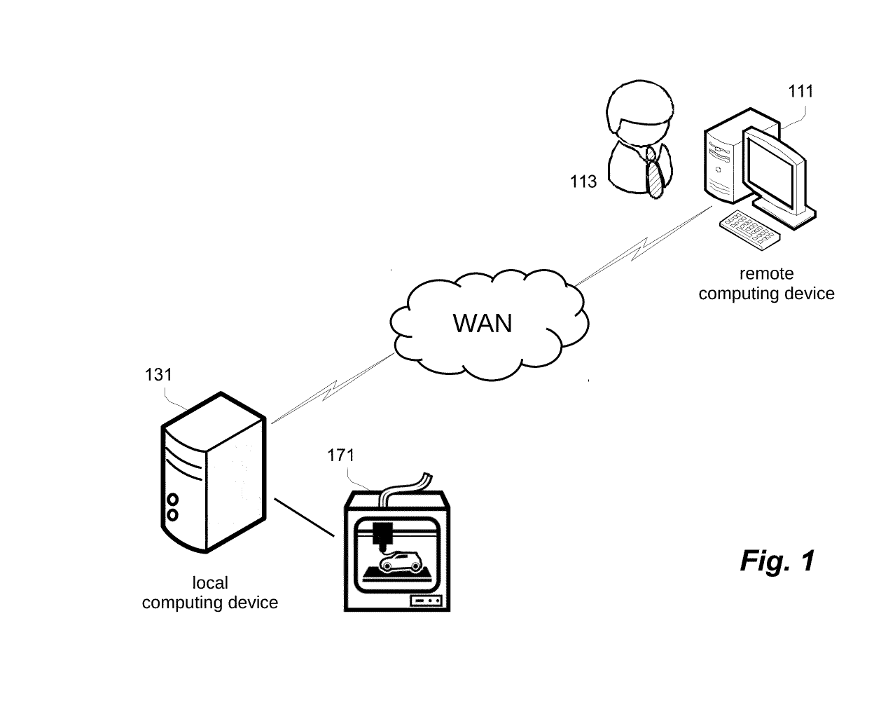

FIG. 1 is a functional overview of one embodiment of a customized model creation system 100, in accordance with aspects of the invention. In this embodiment, the system 100 is composed of a wide area network 101, a remote computing system 111, and a local computing system 131. Very generally stated, a user of the remote computing system 111 connects to the local computing system 131 using the wide area network 101.

In this particular implementation, the user of the remote computing system 111 interacts with the local computing system 131 to customize a model in accordance with the user's desires. More specifically, this embodiment enables the user to transmit an image from the remote computing system 111 to the local computing system 131, which then customizes a model based on the image. More specifically, one preferred embodiment customizes a physical ‘model’ by creating a three dimensional representation of a head using an image provided by the user. For the purpose of this description, the term ‘model’ includes any figurine, doll, action figure, or the like. In another preferred embodiment, a pre-existing video includes a character specially configured to accept a customized 3D model of a head based on the image. In this way, the 3D model may be used to simulate the existence of the person from the image in the video, as is more fully described below.

In the preferred embodiment, the wide area network 101 may be any computer network capable of inter-connecting disparate computing systems. The Internet is one example of the wide area network 101. The wide area network 101 may be based on any computing technology capable of transmitting digital information from one computing location to another, such as wired networking technologies (e.g., Ethernet) or wireless networking technologies (e.g., Wi-Fi, WLAN, CDMA, TDMA, GSM, PCS, etc.)

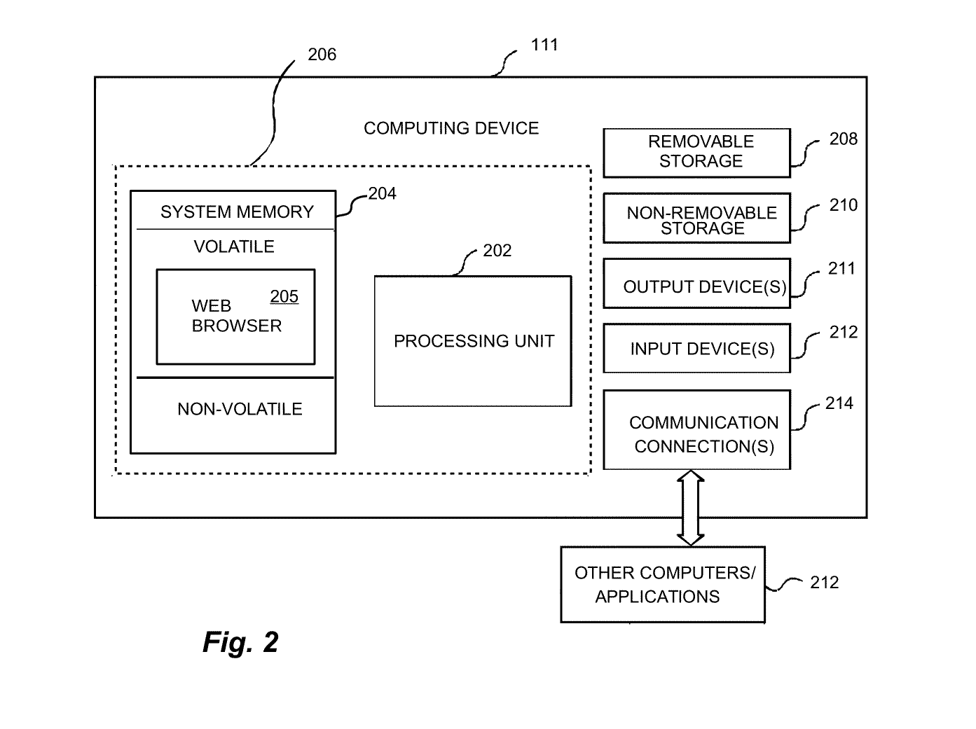

A remote computing system 111 (or “remote computer”) is connected to the wide area network 101, and enables a user (such as user 113) to remotely create a 3D figure. A specific embodiment of an illustrative remote computing system 111 is illustrated in FIG. 2 and described below. Generally stated, the remote computer 111 includes software components to connect to other computers over a network, such as the wide area network 101. Using those software components, the remote computer 111 enables user 113 to transmit an image, such as an image of the user's face or head. Once that image is transmitted, the remote computer 111 enables the user to customize a 3D model of a head based on the image. Once the 3D model is to the user's liking, the remote computer 111 causes a 3D figure to be created using the 3D model. Alternatively, the remote computer 111 generates a video that incorporates the 3D model.

A local computing system 131 (or “local computer”) hosts server software and application software for creating figures customized using 3D models. The figures may be physically created from digital representations using a 3D printer 171 (described below). The digital representations are generally described as being part standard form and part customized form. More specifically, the digital representation of the figure is based largely on a standard form, which digitally represents a substantially human body or head. For example, the standard form may describe general characteristics of a body, such as legs, a torso, arms, and a head. Of the standard forms, there may be one or more options, such as a male standard form and a female standard form.

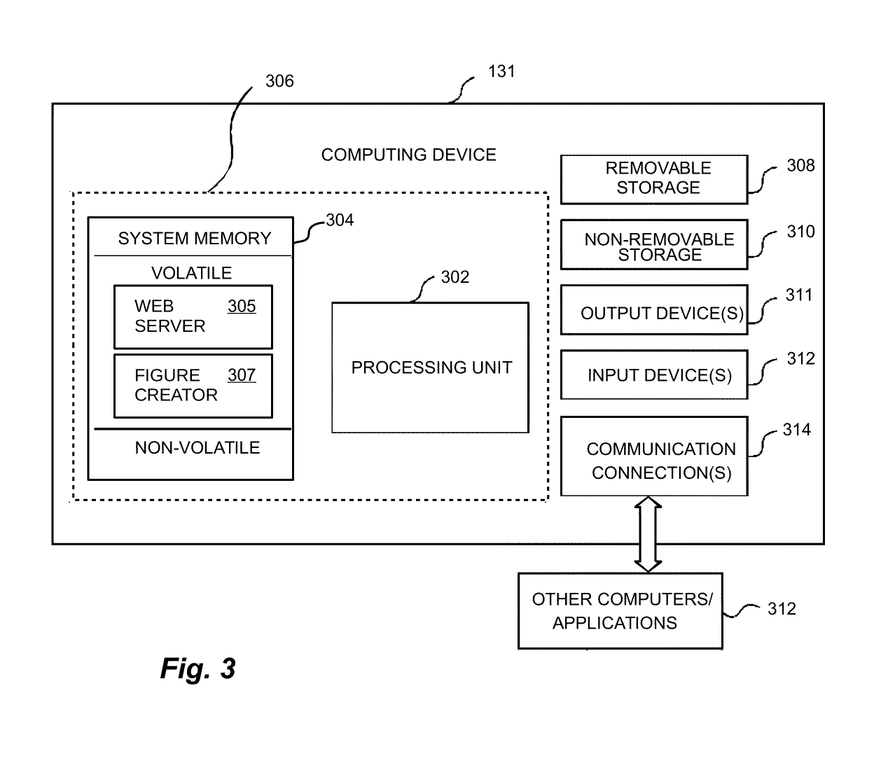

In addition to the standard form, the digital representation includes a customized form, such as a form of a head which is customized using a 3D model of a head. The customized 3D model of the head is created by modeling an image of a face or head provided by the remote computer 111. In one specific implementation, the local computer 131 includes software components for rendering a 3D model of a head using an image of a face. Specific components are described in greater detail below in conjunction with FIGS. 2 and 3. Briefly stated, the local computer 131 creates a 3D model of an entire head based on the image provided by the user. Once the 3D model is created, the local computer 131 allows certain features of the 3D model to be customized to the user's liking, such as hairstyle, facial hair, eyewear, or the like.

Once the entire digital representation of the figure is customized and created, the local computer 131 may cause a physical representation to be created using a three dimensional printer 171. The three dimensional printer 171 (“3D printer”) is connected to the local computer 131 and is operative for creating three dimensional objects. More particularly, the 3D printer 171 is based on any of various processes for making a three-dimensional object of almost any shape from a 3D model or other electronic data source primarily through additive processes in which successive layers of material are laid down under computer control. One specific example of an acceptable 3D printer 171 is the ZPrinter 650 from the Z Corporation.

Alternatively, the digital representation may be only the customized form, such as a customized 3D model of a face and head. In this alternative embodiment, a pre-existing physical figure (referred to as a “preform”) may be used. In this manner, the customized 3D model of the head may be physically created using the 3D printer 171 and then affixed to the preform, thereby reducing the amount of 3D printing which must be done.

In yet another alternative, the customized 3D model of the face and head may be used to customize a video, such as a pre-existing video that incorporates a configurable character that is able to be embellished with a customized 3D model.

FIG. 2 is a functional block diagram illustrating components of a remote computing system that may be implemented in certain embodiments. The computing system 111, in one basic configuration, includes at least a processor 202 and a memory 204. Depending on the exact configuration and type of computing device, memory 204 may be volatile (such as RAM), non-volatile (such as ROM, flash memory, etc.), or some combination of the two. This basic configuration is illustrated in FIG. 2 by dashed line 206.

Additionally, computing system 111 may have other features and functionality. For example, computing system 111 may also include additional storage (removable and/or non-removable) including, but not limited to, magnetic or optical disks or tape. Such additional storage is illustrated in FIG. 2 by removable storage 208 and non-removable storage 210. Computer storage media includes volatile and nonvolatile, removable and non-removable media implemented in any method or technology for storage of information such as computer readable instructions, data structures, program modules or other data. Memory 204, removable storage 208 and non-removable storage 210 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing system 111. Any such computer storage media may be part of computing system 111.

Computing system 111 includes one or more communication connections 214 that allow computing system 111 to communicate with one or more remote computers and/or applications 213, such as over wide area network 101. Computing system 111 may also have input device(s) 212 such as a keyboard, mouse, digitizer or other touch-input device, voice input device, etc. In this specific embodiment, computing system 111 may include a digital camera for electronically capturing images, such as an image of a user's face and head. Output device(s) 211 such as a monitor, speakers, printer, PDA, mobile phone, and other types of digital display devices may also be included. These devices are well known in the art and need not be discussed at length here.

In accordance with this embodiment, a user of the remote computer 111 may use web browser 205 to interact with other computers over wide area network 101. More specifically, the web browser 205 may be used to connect to local computer 131 to interact with software components on the local computer 131 for creating a digital representation of a figure.

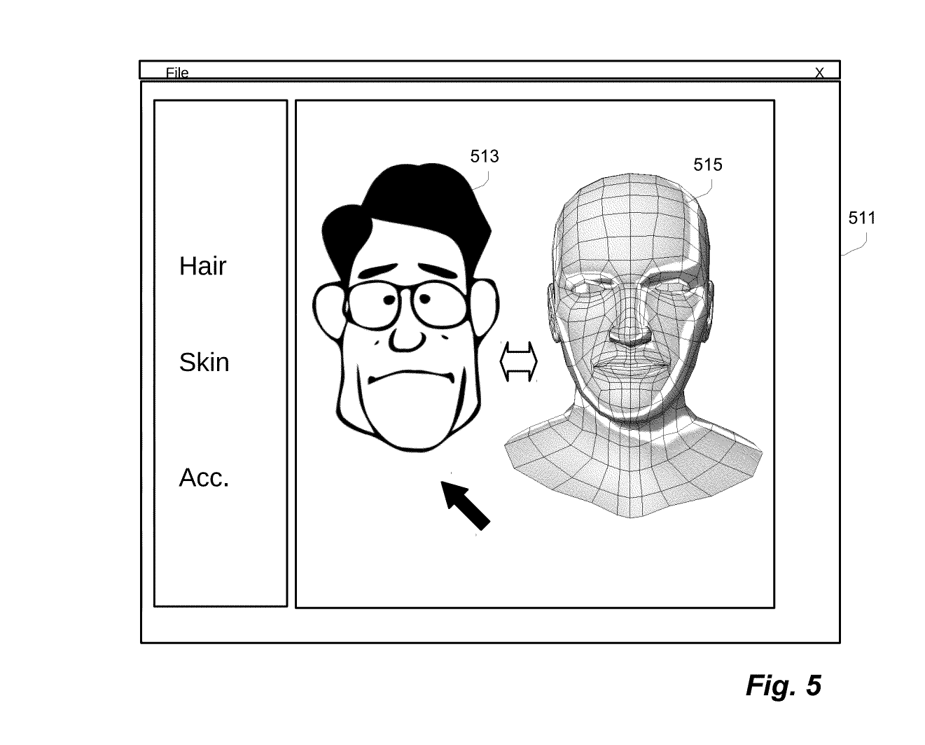

Referring briefly to FIG. 5, the user provides an image, such as an image of a human face and head, to the local computer 131 over the wide area network 101. The user may then interact with a video creation system 100 to create a 3D model of a head which resembles the image provided by the user. The user may use the web browser 205 to interact with a web interface 511 to upload a photograph 513. The photograph 513 may then be overlaid onto a 3D model of a head form 515.

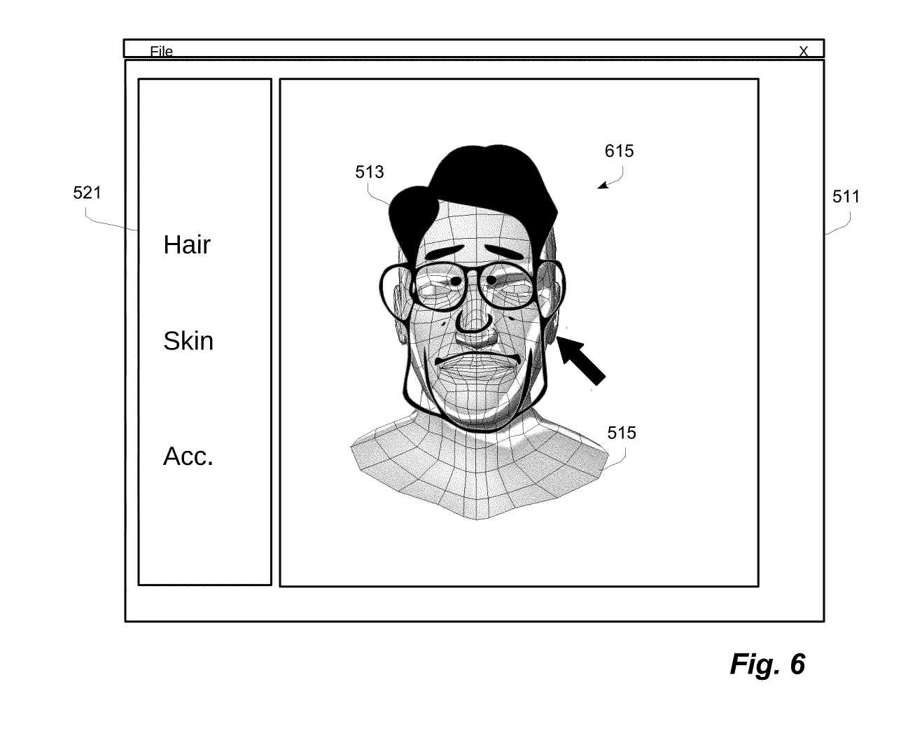

Referring briefly to FIG. 6, using the interface 511, the user creates a customized 3D model 615, picks a desired hairstyle, and may even add accessories. The user creates the 3D model 615 by aligning key points on the head form 515 with corresponding points on the photograph 513 to indicate the size, shape and location of key facial features, such as eyes, nose and mouth, as well as the height, width and shape of their head. The facial features may be either manually input or automatically detected.

The user may pick a hairstyle from a gallery 521, which is applied to the head. The gallery 521 may also include many other options, such as alternative skin tones, facial hair, accessories (e.g., eyewear, jewelry, piercings, etc.), tattoos, scars, and the like. The interface 511 allows the photograph 513 to be rotated and/or zoomed in and out for correct positioning onto the head form 515.

FIG. 3 is a functional block diagram illustrating components of a local computing system 131 that may be implemented in certain embodiments. The components illustrated in FIG. 3 perform the same general functions as similarly-named components illustrated in FIG. 2 and described above. However, the local computing system 131 may be specially configured to operate in a high-tempo environment, such as in a server farm or other web server implementation. Accordingly, some components are more likely absent from the local computing system 131, such as an optical camera, and other components are more likely of superior specifications, such as non-volatile storage within system memory 304.

In addition, the local computing system 131 further includes a web server 305 component and a video creator 307 component. These two components operate in conjunction to enable the local computing system 131 to host and provide the figure creation service envisioned by the preferred embodiment.

The web server 305 may be any software component operative to host web requests over the wide area network 101. For example, the web server 305 may include subcomponents for handling requests using HTTP, HTTPS, and the like. In addition, the web server 305 may further include components for handling the creation of static and dynamic pages, such as using HTML code and PHP code. The Apache HTTP Server is one specific example of a suitable web server 305 component.

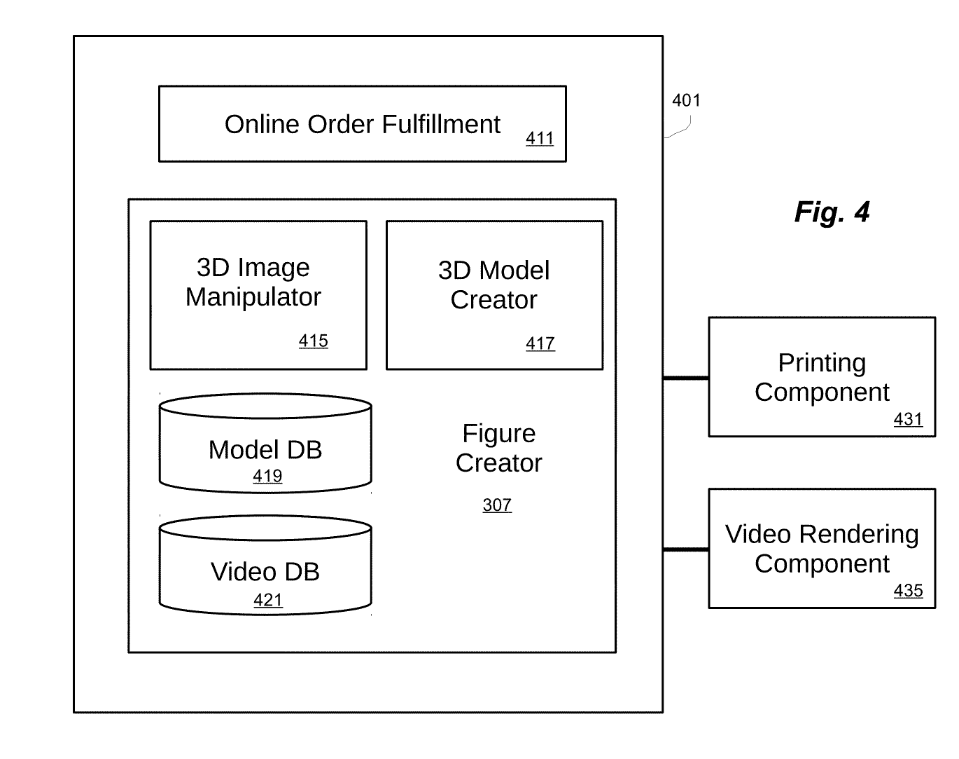

The video creator 307 is illustrated in greater detail in FIG. 4 and described below. Generally stated, the video creator 307 provides the operative components to enable a remote user to connect to the local computing system 131 and create a customized figure. In the preferred embodiment, the video creator 307 is operative to receive at least one image from a remote user, such as an image of a face, and provide an interface that allows the remote user to customize a 3D head form to resemble the image. The video creator 307 may then cause a physical instance of the customized 3D head form, which may be attached to a pre-existing standard body form. Alternatively, the video creator 307 may cause a physical instance of figure having an entire body and head to be created. In yet another alternative, the video creator 307 may incorporate the customized 3D head form into a video, such as an animated e-card, or the like.

FIG. 4 is a functional block diagram generally illustrating elements of a video creator 307 component that may be implemented in certain embodiments. In this embodiment, the video creator 307 includes a 3D image manipulator 415, a 3D model creator 417, a model data store 419, and a video data store 421.

The video creator 307 exposes an interface that allows interaction with the 3D image manipulator 415. Generally stated, the 3D image manipulator 415 provides functions to enable a user to upload an image (e.g., a digital photograph) to the video creator 307 and to manipulate that image. For instance, the 3D image manipulator 415 enables a user to optionally alter the image, such as by changing hair style, skin tone, size, and the like. Alternatively, the video creator 307 may include functions to compare given hairstyles in a gallery 521 with the detected hairstyle in the image 513 to attempt to select an appropriate pre-existing hair style which can be better customized and manipulated using the 3D image manipulator 415.

The 3D image manipulator 415 blends the facial portion of the image into an even skin color for the rest of the head form, which is automatically detected based on the photo and may be optionally adjusted by the user. The 3D image manipulator 415 may apply photo enhancements to reduce shadows or improve coloring. These steps may be done with or without a user taking action.

The video creator 307 also includes a 3D model creator 417, which operates to enable a remote user to create a 3D model based on the image uploaded by the remote user. The 3D model creator 417 provides functions that enable the remote user to alter and customize a generic three dimensional head form to transform the generic head form into a customized 3D model that resembles the real-world incarnation of the user's face and head. A software instance of the generic three dimensional head form may be stored as a digital representation in a model data store 419. Other generic forms may also be stored in the model data store 419, such as full-figure models, partial-figure models, animal models, and the like.

The software components of the video creator 307 cooperate to create the 3D model by analyzing the image to extract certain key features of the face which represent depth and distance between facial features. The 3D model is then presented for customization by the user.

In one particular implementation, the video creator 307 is capable of producing an adequate 3D model using at least one image (e.g., one photograph of a face and head). The 3D model creator 417 enables the manual manipulation and alteration of the generic 3D head form using even a single photograph. Of course, multiple photographs could also be used to improve accuracy.

In one preferred embodiment, the video creator 307 is used to create a 3D model of an entire head, not merely a facial overlay. In this manner, the rendered 3D model more accurately represents the user's actual face and head, resulting in a superior end product.

A printing component 431 may be provided to convert the customized 3D model into a real-world physical instance of the customized 3D model. The printing component 431 (also referred to as a “printer driver” or “printing subsystem”) includes functions to output appropriate printer codes to cause a 3D printer connected to the local computing system 131 to generate the physical instance of the customized 3D model.

In another preferred embodiment, a video rendering component 435 may be provided to incorporate the customized 3D model into a video to simulate the existence of the subject of the image in the video. For example, the video data store 421 may include one or more pre-existing videos with each having a form character specially configured to be altered by having the customized 3D model applied to the character. In this way, the video may be rendered, using the video rendering component 435, such that the person who is the subject of the 3D model may appear as a character in the video.

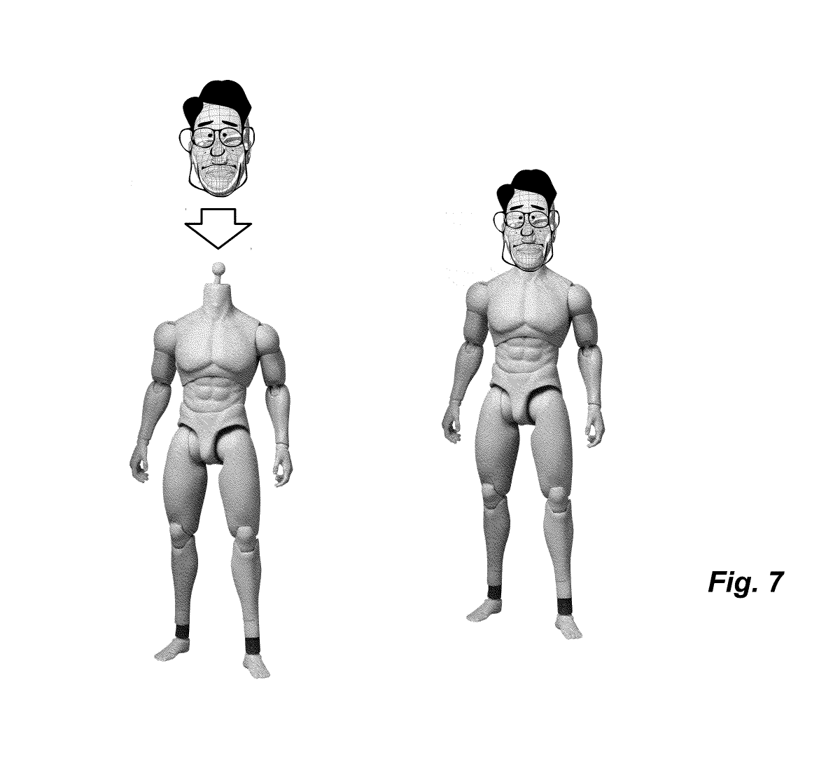

Referring briefly to FIG. 7, in one implementation, the customized 3D model 705 is designed with an appropriate attachment piece at the base of the 3D head model (e.g, the neck region) to affix it to a preform 710 as a complete head. This feature results in a superior end product over an alternative embodiment in which only a facial mask is created to overlay onto a figure's existing face. In another alternative, the entire customized FIG. 712 may be created as one piece using the 3d printer 171. This alternative may enable greater customization, but result in greater cost of manufacture.

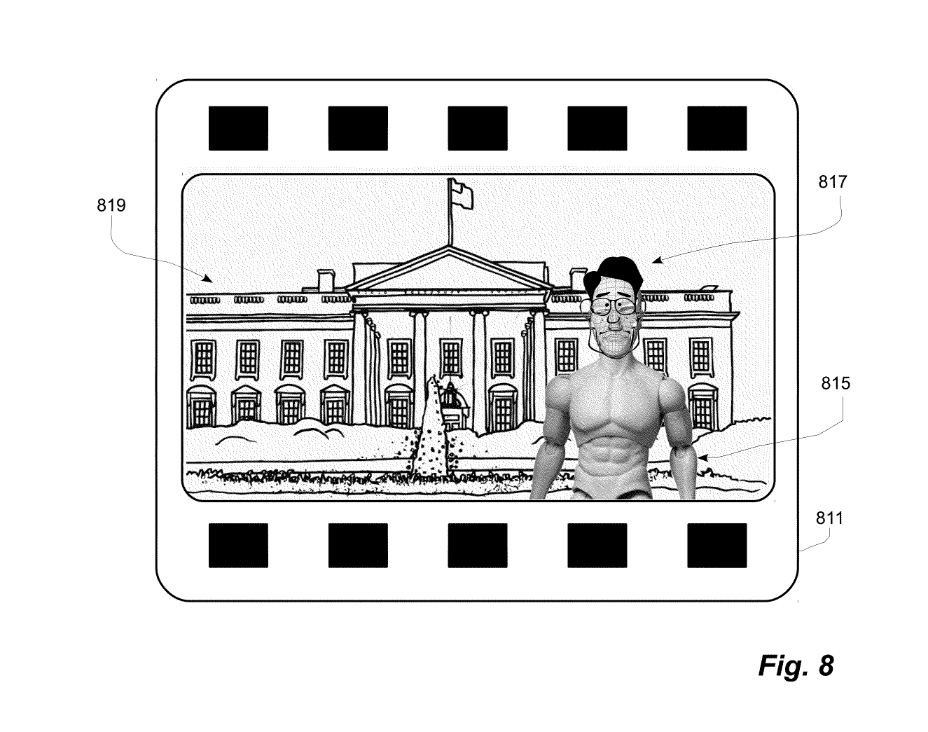

Referring briefly to FIG. 8, in another implementation, the customized 3D model 817 may be incorporated onto a specially configured character 815 within a pre-existing video 811. In this way, the 3D model 817 simulates the existence of a particular person in a scene 819 of the video. Uses of the system are numerous. For example, embodiments enable a user to create, for instance, customized video greeting cards with the user's own image or face. In another example, special videos can be created to allow the user to simulate being in a particular scene of a movie, or the like. The possibilities are endless.

Returning to FIG. 4, an order fulfillment component 411 may be included to enable the remote user to purchase instances of the customized 3D figure or video. For example, it is envisioned that remote users may connect to the local computing system 131 and cause to be created physical figures customized to the users' liking or customized videos including the 3D model. Once done, the users may purchase such physical figures or videos for themselves, to give away as gifts, or to transmit as e-cards, or the like.

Although the invention has been described in the context of certain preferred embodiments, those skilled in the art will understand that these embodiments are merely illustrative and that many alternative embodiments are taught and suggested by this disclosure. Accordingly, the invention is not limited to these specific preferred embodiments, and rather, the invention is limited only by the following claims, which alone define the full scope of the invention.

The invention is:

1. A system for creating a customized video, comprising:
a web server component including functions to receive input from a remote computing system over a wide area network, the input including at least one image representing facial features;
a video creator component, comprising:
a 3D image manipulator subcomponent including functions to receive the image and to manipulate the facial features of the image;
a 3D model creator subcomponent to create a 3D model based on the image, the 3D model creator including functions to enable alteration and customization of a generic 3D head form to transform the generic 3D head form into a customized 3D model that resembles the facial features; and
a video rendering component configured with functions to incorporate the customized 3D model into a pre-existing video to simulate the existence of the subject of the image in the pre-existing video.

2. The system recited in claim 1, wherein the customized 3D model comprises a head having a face that resembles the facial features.

3. The system recited in claim 1, wherein the customized 3D model comprises an entire figure with a head, the head having a face that resembles the facial features.

4. The system recited in claim 1, further comprising an order fulfillment component configured to execute a purchase and sale transaction over the wide area network, and to cause the pre-existing video, customized with the 3D model, to be delivered in accordance with the purchase and sale transaction.

5. A method for creating a customized figure, comprising:
receiving input at a web server from a remote computing system over a wide area network, the input including at least one image representing facial features;
receiving instructions through an interface hosted by the web server to manipulate the facial features of the image in accordance with options offered by the web server;
creating a customized 3D model based on the image, including customizing a generic 3D head form to transform the generic 3D head form into the customized 3D model that resembles the facial features; and
converting the customized 3D model into codes sufficient to enable a video rendering component to incorporate the customized 3D model into a video and simulate the existence of a subject of the image in the video.

6. The method recited in claim 5, wherein the customized 3D model comprises a head having a face that resembles the facial features.

7. The method recited in claim 5, wherein the customized 3D model comprises an entire figure with a head, the head having a face that resembles the facial features.

8. The method recited in claim 5, further comprising:
fulfilling a purchase and sale transaction over the wide area network, and
causing the video to be delivered in accordance with the purchase and sale transaction.
